(19) United States
(12) Patent Application Publication
(10) Pub. No.: US 2005/0016387 A1
(43) Pub. Date: Jan. 27, 2005

(54) The Rib-O-Wheel BBQ Rotisserie Basket(s) Attachment.

(76) Inventor: Michael Dwayne Sigman, Sammamish, WA (US)

Correspondence Address: MICHAEL D.SIGMAN, 1745 DORRANCE DR., SAN JOSE, CA, 95125, US

(21) Appl. No.: 10/249,696

(22) Filed: Apr. 30, 2003

(51) Int. Cl. A47J 37/04

(52) U.S. Cl. 99/421 R

(57) ABSTRACT

Rib-O-Wheel for a gas fired Bar-B-Cue rotisserie. The Rib-O-Wheel comprises four hanging baskets and two basket attachment end wheels constructed from stainless steel or high tensile steel coated with chrome or a porcelain finish. The basket attachment end wheels slide onto any standard 1/4 in. rotisserie bar and are secured in place by a thumb screw. The baskets are placed between the basket attachment end wheels and are hung on fixed pins. The baskets rotate around the attachment end point pins as the rotisserie rotates around its center axis.

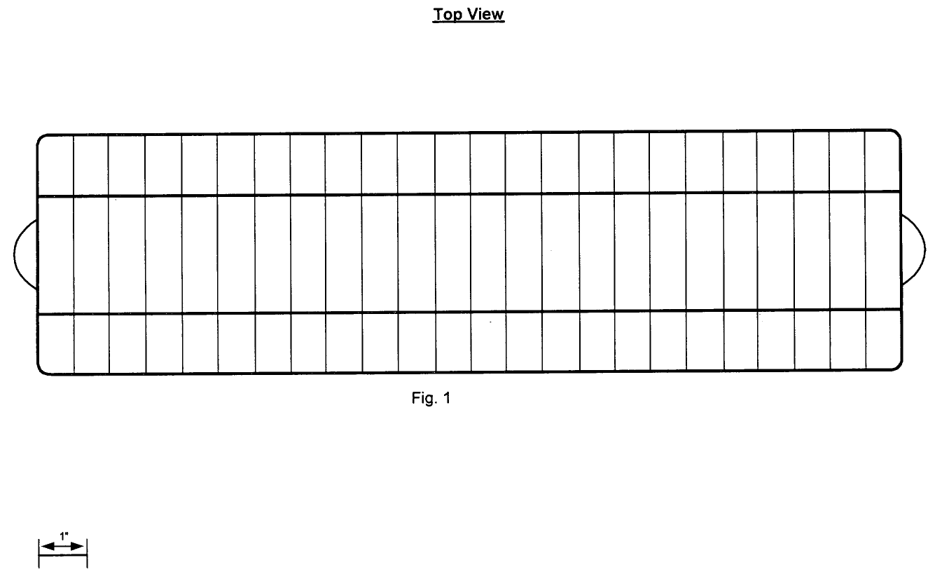

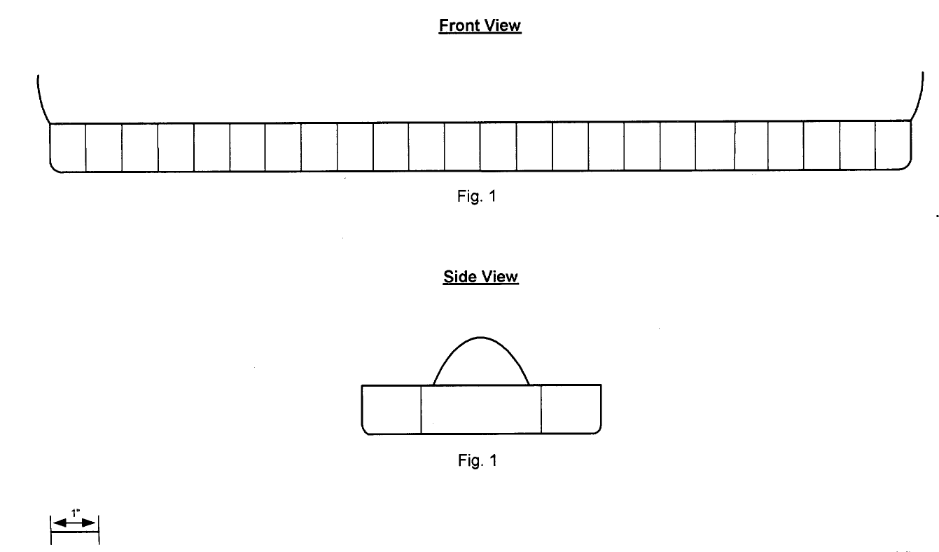

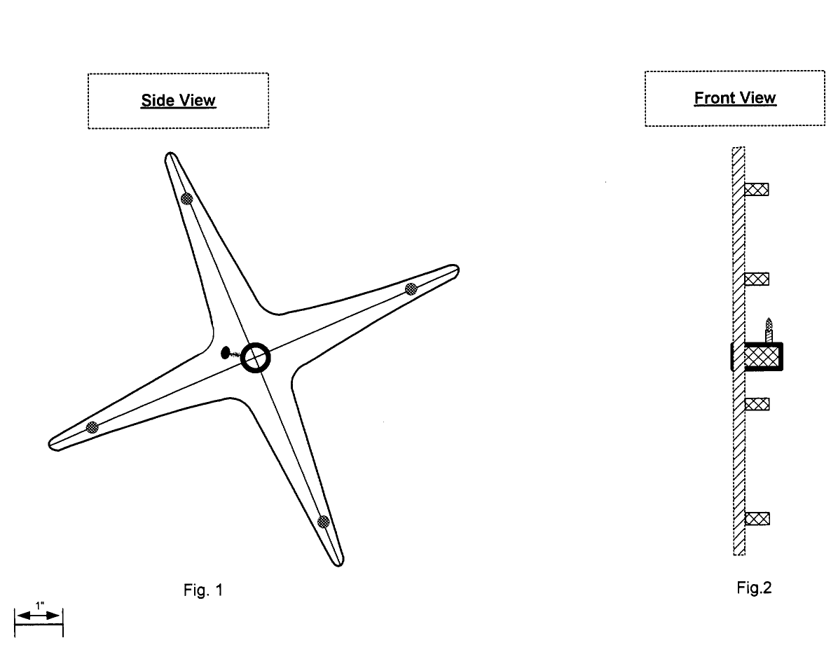

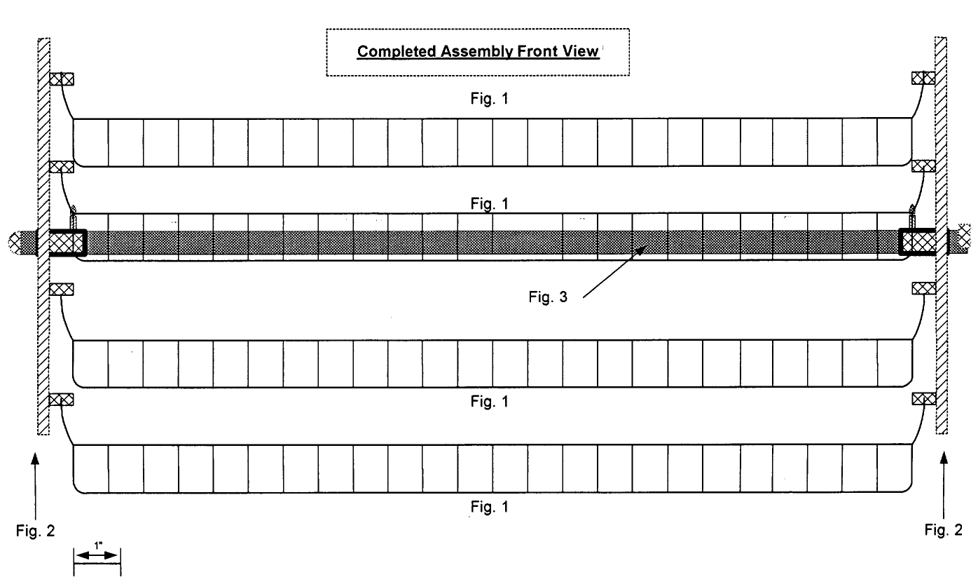

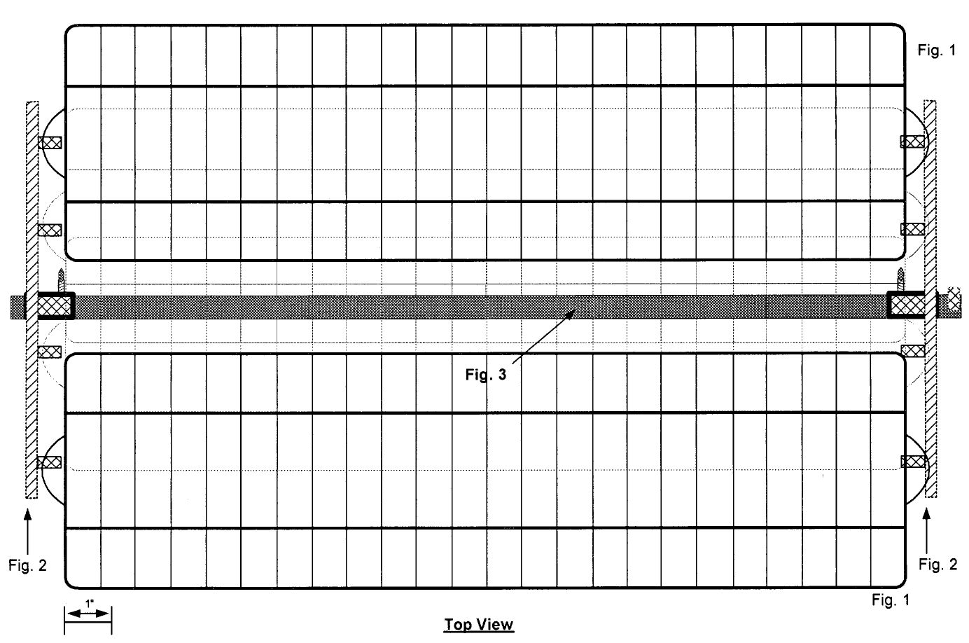

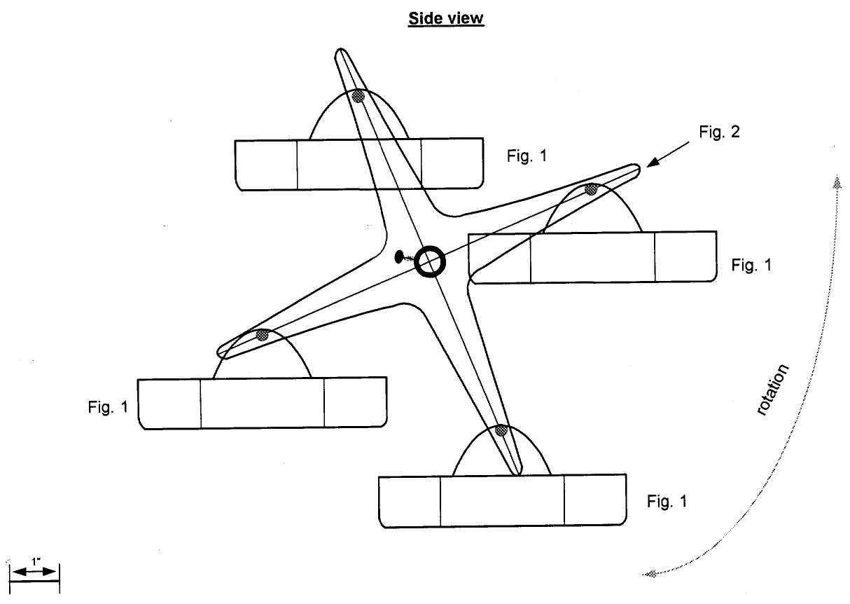

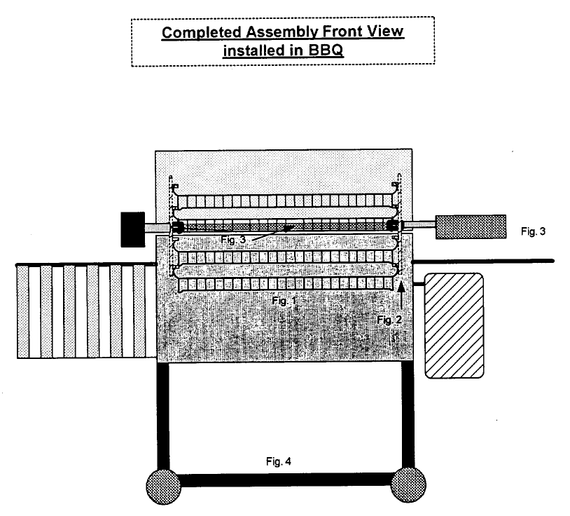

### BACKGROUND OF INVENTION

Gas fired Bar-B-Q's are a common home appliance. Most gas fired BBQ's have the option of attaching an electric rotisserie. Electric rotisseries are used to cook meat, poultry, fish, vegetables, and breads by slowly rotating them over the gas burners instead of placing those foods directly on the cooking grills. Electric rotisseries consist of an electric motor than turns a long horizontal metal bar to which various attachments can be installed.

More specifically, rotisserie attachments are designed to hold foods in place around a horizontal central plane of axis and to slowly rotate the foods over the cooking burners. Rotating the foods around this horizontal plane provides for a more even heat application over the food surface and a self basting action. Rotisserie attachments usually consist of a circular or rectangular basket or rectangular side-by-side basket arrangements or prongs or forks at each end.

There is a need for a multi-basket design which would allow up to 4 baskets to be attached to a BBQ rotisserie. The Rib-O-Wheel Rotisserie Basket(s) Attachments will allow for double the food amount of current rotisserie basket designs. The Rib-O-Wheels unique design provides for a better self basting action and easier access and removal of foods from the rotisserie. The Rib-O-Wheel can be easily manufactured from readily available materials currently used for rotisserie attachments.

### SUMMARY OF INVENTION

The Rib-O-Wheel is a rotisserie attachment for use with gas fired BBQ grills that are designed to accept an electric rotisserie. Up to four hanging baskets can be attached to two end support wheels. The baskets and the end wheels are designed so that the attached baskets center of gravity is lower than the basket end attachment points providing for a stable cooking platform. The baskets and end wheels are made of stainless steel for easy cleaning.

### BRIEF DESCRIPTION OF DRAWINGS

Drawing 1 is a top view of a basket attachment.

Drawing 2 is a front view and side view of a basket attachment.

Drawing 3 is a side view and front view of the end wheel assembly.

Drawing 4 is a fully assembled four basket arrangement front view.

Drawing 5 is a fully assembled four basket arrangement top view.

Drawing 6 is a fully assembled four basket arrangement side view.

Drawing 7 is a fully assembled four basket arrangement installed in a typical gas fired BBQ.

### DETAILED DESCRIPTION

The Rib-O-Wheel BBQ Basket(s) attachment of the invention is described with reference to the drawings and in the following paragraphs. A typical style gas fired BBQ with the Rib-O-Wheel installed is depicted in Drawing 7.

The typical gas fired BBQ depicted in Drawing 7 has accommodations for the attachment of a standard electric rotisserie. A standard electrical rotisserie attaches to the exterior end surface of the BBQ and usually includes a long horizontal bar to which cooking attachments are installed. The Rib-O-Wheel consists of four wire baskets and two end wheels, referenced in Drawings 1-6.

With reference to Drawings 1 and 2, a single basket is depicted in each of four views; top, front, side, and end. The baskets attachment point is higher than the center of gravity for the basket and accompanying food giving the basket significant stability. The baskets are manufactured using a wire frame construction of either stainless steel, chrome plated wire, or porcelain coated wire.

With reference to Drawings 3, one of the end wheel assemblies is show in side view and front view. The end wheel assemblies have four adjustable attachment points where each end of a basket attachment point connects. The end wheels four attachment points are adjustable to accommodate differing clearance restrictions of the various BBQ manufacturers. The end wheel assemblies are manufactured using either stainless steel, chrome plated steel plate or porcelain coated steel plate.

1. A BBQ rotisserie attachment consisting of four baskets and two end wheel plates for the use within a standard gas fired BBQ grill. The assembly can be used in one, two, three, or four basket configurations as needs dictate. The Rib-O-Wheel will rotate about the center of the axis of the rotisserie bar and allow for even heat application to each basket.

2. The baskets of claim 1 wherein the baskets end attachment points are generally 1 inch above the actual basket and are centered midway at the basket ends.

3. The baskets of claim 1 wherein the baskets are constructed of steel wire consisting of either stainless steel, chrome plated steel, or porcelain coated steel, with a wire diameter of between 1/16th inches and ⅛ inches and welded at all cross points.

4. The baskets of claim 3 wherein the shaped baskets have a greater diameter at the top of the basket than the diameter at the bottom.
